(19) United States
(12) Patent Application Publication
(10) Pub. No.: US 2011/0128627 A1
(43) Pub. Date: Jun. 2, 2011

(54) ANTIGLARE FILM AND DISPLAY DEVICE

(75) Inventor: Yoshitaka KURAHASHI, Inazawa-shi (JP)

(73) Assignee: BROTHER KOGYO KABUSHIKI KAISHA, Nagoya-shi (JP)

(21) Appl. No.: 12/957,382

(22) Filed: Nov. 30, 2010

(30) Foreign Application Priority Data
Nov. 30, 2009 (JP) 2009-272230

(51) Int. Cl. G02B 5/02; G02B 1/10; B05D 5/06

(52) U.S. Cl. 359/599; 359/601; 427/162

(57) ABSTRACT

To an adhesive tape, which is attached to a display of a display device, an antiglare film is attached so that a resin coating layer of the antiglare film faces down and so that an antiglare layer of the antiglare film is on a front side. In this state, reflection of extraneous light can be prevented or reduced, because the antiglare layer is on the front side of the display. The antiglare film is peeled off the display of the display device, flipped over, and re-attached so that the antiglare layer faces the display of the display device and so that the resin coating layer is on the front side (upper side). In this state, the display is provided with clear and excellent clarity of an image viewed through the antiglare film 1, because the resin coating layer having a substantially flat shape is on the front side (upper side) of the display.

### CROSS-REFERENCE TO RELATED APPLICATIONS

The present application claims priority to and the benefit of Japanese Patent Application No. 2009-272230, which was filed on Nov. 30, 2009, the disclosure of which is incorporated herein by reference in its entirety.

### BACKGROUND OF THE INVENTION

1. Field of the Invention

The present invention relates to an antiglare film and a display device. In particular, the present invention relates to an antiglare film that is disposed on a display surface of a display device, such as an electrophoretic display or a liquid crystal display, and a display device including the antiglare film.

2. Description of the Related Art

Display devices including an electrophoretic display and a liquid crystal display are known. An antiglare film is disposed on such a display device in order to prevent reflection of light that may occur when the display device is used in bright environments such as outdoors. Existing antiglare films include an antiglare layer disposed on a surface of a backing. The antiglare layer is made of a resin including fine particles of amorphous silica or resin beads. The fine particles protrude from a surface of the antiglare layer, so that the surface has a small asperity. The antiglare film is produced by coating the backing with a paint, which includes fine particles, a resin, a solvent, etc., and then drying the paint.

This production method, which includes application of a paint including fine particles to the backing, is widely used, because the method is inexpensive and has a high productivity. However, although the antiglare film made by this method has an antiglare function, the antiglare film has a problem because the asperity of the surface is formed by the protrusions of the fine particles. That is, the protrusions of the fine particles increase the haze value of the film and make an image whitish, whereby the contrast and the sharpness of the image are reduced. To address this problem, the following antiglare film has been proposed. The antiglare film includes an antiglare layer disposed on a backing. The antiglare layer is formed by coating the backing with a paint including a resin, a solvent, and fine particles, and then drying the paint. During drying, Benard cells are formed on a surface of the coating layer due to convection that occurs when the solvent evaporates. By curing the resin of the paint in which the Benard cells have been formed, the thickness of the coating layer is made to be equal to or larger than the average diameter of the fine particles and equal to or smaller than triple the average diameter of the fine particles.

### SUMMARY OF THE INVENTION

However, existing antiglare films have a problem in that, although the antiglare layer thereof can reduce reflection of light, the display is blurred and has not clarity of an image viewed through the antiglare film.

The present invention, which has been achieved to address the problem. The present invention provides an antiglare film and a display device that perform an antiglare function when there is reflection of light and provides a clear display when there is no reflection of light and clarity of an image viewed is needed. The present invention provides display suitable for the environment. The present invention also provides an antiglare film and a display device that can withstand repeated use.

In an embodiment of the invention, an antiglare film comprises a film that is optically transparent and substantially plate-shaped, an antiglare layer disposed on a first surface of the film, a first resin coating layer disposed at a surface of the antiglare layer opposite to the film, and a second resin coating layer disposed on a second surface of the film, the second surface being opposite to the first surface, wherein the second resin coating layer is substantially flat.

In another embodiment of the invention, a display device comprises an antiglare film. The antiglare film comprises a film that is optically transparent and substantially plate-shaped, an antiglare layer disposed on a first surface of the film, a first resin coating layer disposed at a surface of the antiglare layer opposite to the film, and a second resin coating layer disposed on a second surface of the film, the second surface being opposite to the first surface, wherein the second resin coating layer is substantially flat. The display device also comprises a double-sided adhesive that attaches the antiglare film to a surface of the display device, wherein adhesion of an adhesive surface of the double-sided adhesive adjacent to the antiglare film is weaker than adhesion of an adhesive surface of the double-sided adhesive adjacent to the display device.

In yet another embodiment of the invention, a method of manufacturing an antiglare film comprises providing a film having a first surface and a second surface opposite the first surface, disposing a plurality of resin beads on the second surface of the film, adhering the plurality of resin beads to the second surface of the transparent film using a resin adhesive, calcifying the resin adhesive containing the plurality of resin beads to form an antiglare layer, providing a first resin coating layer at a surface of the antiglare layer, and providing a second resin coating layer at the first surface of the film. Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a longitudinal sectional view illustrating the structure of an antiglare film, according to an embodiment of the invention;

FIG. 2 is a longitudinal sectional view of an adhesive tape, according to an embodiment of the invention;

FIG. 3 is a longitudinal sectional view illustrating the structure of a display device in a state in which the antiglare film is used to perform an antiglare function, according to an embodiment of the invention; and

FIG. 4 is a longitudinal sectional view illustrating the structure of the display device in a state in which the antiglare film is used to increase clarity of an image viewed through the antiglare film, according to an embodiment of the invention.

### DESCRIPTION OF THE PREFERRED EMBODIMENTS

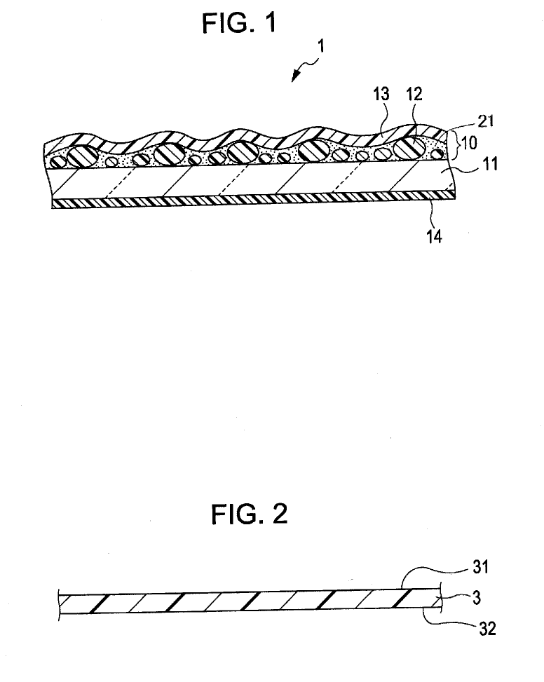

Hereinafter, an antiglare film 1 according to an embodiment of the invention and a display device 2 including the antiglare film 1 will be described with reference to the drawings. The drawings illustrate examples of the structures of the antiglare film 1 and the display device 2, which are used to describe the technical characteristics of an embodiment of the invention. The structures are not limited to these examples. FIGS. 1 to 4 illustrate the asperity of an antiglare layer 10 in an exaggerated manner for ease of understanding. In reality, the asperity is very small, e.g., a few micrometers.

FIG. 1 describes the antiglare film 1, according to an embodiment of the invention. The antiglare film 1 may be attached to a surface of a display panel of an electrophoretic display, a liquid crystal display, or the like. As illustrated in FIG. 1, the antiglare film 1 may comprise a film 11, e.g., a backing 11. The film 11 may comprise a transparent polymer film, the antiglare layer 10, and a resin coating layer 14, e.g., hard coating layer 14. The antiglare layer 10 may be disposed on a front surface, e.g., an upper surface as shown in FIG. 1, of the film 11. The resin coating layer 14 may be disposed on a back surface of the film 11.

The film 11 may comprise various transparent plastic films. For example, the film 11 may comprise a polyethylene terephthalate film, a polycarbonate film, or the like. The thickness of the film 11 may be, for example, about 0.1 mm. The antiglare layer 10 may comprise a plurality of small beads 12 and a resin coating layer 13, e.g., a hard coating layer 13. The beads 12 may comprise a synthetic resin, and may have diameters in the range of about 2 to 3 μm. The beads 12 may diffuse light that passes through the antiglare layer 10. The beads 12 may be attached to the front surface of the film 11 by using a transparent adhesive. The transparent adhesive is a resin filling 21. The resin filling 21 is wrapped around the beads 12 and calcified. The resin coating layer 13 may be formed at a surface of the the antiglare layer 10, and may be formed to cover the beads 12. The thickness of the film 11 and the diameters of the beads 12 may be determined according to the desired properties of the antiglare film.

The thickness of each of the resin coating layers 13 and 14 is, for example, in the range of about 1 to 2 μm. The resin coating layers 13 and 14 may comprise, for example, a silicone resin, an acrylic resin, or a melamine resin.

With such a structure, the upper surface of the antiglare film 1 illustrated in FIG. 1 may diffuse light, whereby the antiglare film 1 may reduce reflection of the light and may perform an antiglare function. The back surface, e.g., the lower surface as shown in FIG. 1, of the antiglare film 1 may be substantially flat. The resin coating layer 14 may have a certain thickness, and may be disposed on the back surface of the antiglare film 1. Therefore, the back surface diffuses less light than the upper surface of the antiglare film 1, and the back surface does not blur an image. Thus, use of the antiglare film 1 may result in clear and excellent clarity of an image viewed through the antiglare film 1.

FIG. 2 describes the structure of an adhesive tape 3, according to an embodiment of the invention. The adhesive tape 3 may be used to attach the antiglare film 1 having the structure described above to a surface of a display panel of a display. The display may be an electrophoretic display, a liquid crystal display, or the like. As illustrated in FIG. 2, the adhesive tape 3 is double-sided. The adhesive tape 3 has a first surface and a second surface, and the second surface has a lower adhesion than the first surface. That is, the second surface, e.g., the front surface, e.g., the upper surface as shown in FIG. 2, of the adhesive tape 3 is a low adhesion surface 31. The first surface, e.g., the back surface, e.g., the lower surface as shown in FIG. 2 of the adhesive tape 3 is a high adhesion surface 32. For example, the adhesive tape 3 comprises a backing and an adhesive applied thereon. The backing of the adhesive tape may comprise a polyethylene terephthalate film, and the adhesive may comprise an acrylic adhesive or a silicone adhesive. For example, the adhesive tape 3 may have a thickness of about 25 μm. The adhesion of the low adhesion surface 31 may be 0.1 N/25 mm, and the adhesion of the high adhesion surface 32 may be 5 N/25 mm.

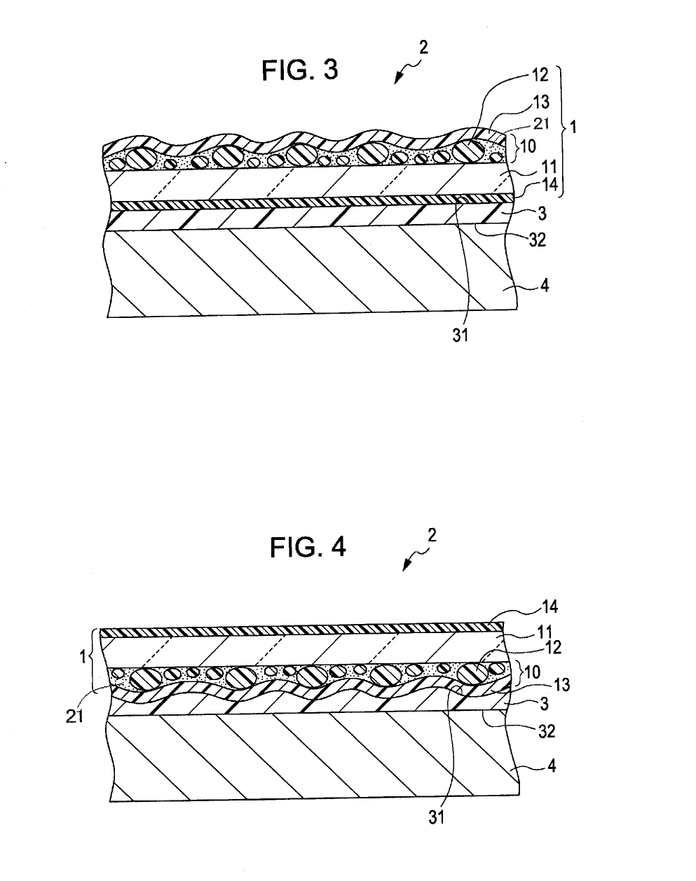

The adhesive tape 3 having the structure described above may be used to attach the antiglare film 1 to a surface of a display 4 of the display device 2 illustrated in FIG. 3. The high adhesion surface 32 of the adhesive tape 3 may be attached to the surface of the display 4, and the low adhesion surface 31 of the adhesive tape 3 may be attached to the back surface of the antiglare film 1. Thus, the adhesive tape 3 attaches the antiglare film 1 to the surface of the display 4 in such a way that the antiglare film 1 can be peeled off the adhesive tape 3 without peeling the adhesive tape 3 off the display 4. The difference between the adhesion of the low adhesion surface 31 of the adhesive tape 3 and the adhesion of the high adhesion surface 32 of the adhesive tape 3 may be determined so that the adhesive tape 3 can perform such a function.

FIGS. 3 and 4 describes cases in which the antiglare film 1 is used by being attached to the display 4 of the display device 2. First, FIG. 3 describes a case in which the antiglare film 1 is used to provide the display 4 with an antiglare function that prevents an influence of extraneous light. As the display 4 of the display device 2, an electrophoretic display or a liquid crystal display, for example, can be used. In particular, a reflective display, such as an electrophoretic display, is prone to the influence of extraneous light as compared with a liquid crystal display. Moreover, because an electrophoretic display generally may have a large size, prevention of reflection of extraneous light using the antiglare film 1 is important. In this case, to the adhesive tape 3, which is attached to the display 4 so that the high adhesion surface 32 faces down, the antiglare film 1 is attached so that the resin coating layer 14 faces down and so that the antiglare layer 10 faces up (on the front side). In this state, the antiglare layer 10 is on the front side (upper side) of the display 4 of the display device 2, whereby the reflection of the extraneous light can be prevented or reduced.

When the display device 2 is used indoors, clear and excellent clarity of an image viewed through the antiglare film 1 may be more important than prevention of the reflection of extraneous light. In this case, the antiglare film 1 is peeled off the display 4 of the display device 2 and flipped over. Then, as illustrated in FIG. 4, the antiglare film 1 is re-attached to the display 4 with the adhesive tape 3 therebetween so that the antiglare layer 10 faces the display 4 of the display device 2 and so that the resin coating layer 14 faces up (on the front side). In this state, the resin coating layer 14, which is flat, is on the front side (upper side) of the display 4. Therefore, the display 4 is provided with clear and excellent clarity of an image viewed through the antiglare film 1. When peeling the antiglare film 1, the adhesive tape 3 is not peeled off the display 4, because the high adhesion surface 32 of the adhesive tape 3 adheres to the display 4. The antiglare film 1 can be readily peeled, because the antiglare film 1 is attached to the low adhesion surface 31 of the adhesive tape 3.

The present invention is not limited to the embodiment, and can be modified in various ways. For example, the display 4 is not limited to an electrophoretic display and a liquid crystal display, and may be a plasma display or a CRT display.

What is claimed is:

1. An antiglare film comprising:
a film that is optically transparent and substantially plate-shaped;
an antiglare layer disposed on a first surface of the film;
a first resin coating layer disposed at a surface of the antiglare layer opposite to the film; and
a second resin coating layer disposed on a second surface of the film, the second surface being opposite to the first surface, wherein the second resin coating layer is substantially flat.

2. The antiglare film according to claim 1, wherein the thickness of the first resin coating layer and the second resin coating layer is between 1 μm and 2 μm.

3. The antiglare film according to claim 1, wherein the first resin coating layer and the second resin coating layer comprise at least one of a silicone resin, an acrylic resin, and a melamine resin.

4. The antiglare film according to claim 1, wherein the film has a thickness of about 0.1 mm.

5. The antiglare film according to claim 1, wherein the film comprises a transparent polymer film.

6. The antiglare film according to claim 5, wherein the film comprises at least one of a polyethylene terephthalate film and a poly carbonate film.

7. The antiglare film according to claim 1, wherein the first resin coating layer is configured to diffuse light that passes through the first resin coating layer, and the second resin coating layer is configured to reduce the amount of diffusion of light that passes through the second resin coating layer.

8. The antiglare film according to claim 1, wherein the first resin coating layer is configured to diffuse more light than the second resin coating layer when light passes through the first resin coating layer and the second resin coating layer.

9. The antiglare film according to claim 1, wherein the first resin coating layer and the second resin coating layer have a greater hardness than the film.

10. The antiglare film according to claim 1, wherein the antiglare layer comprises:
a plurality of resin beads; and
a resin filling that is wrapped around the beads and calcified.

11. A display device comprising:
an antiglare film comprising:
a film that is optically transparent and substantially plate-shaped;
an antiglare layer disposed on a first surface of the film;
a first resin coating layer disposed at a surface of the antiglare layer opposite to the film; and
a second resin coating layer disposed on a second surface of the film, the second surface being opposite to the first surface, wherein the second resin coating layer is substantially flat; and
a double-sided adhesive that attaches the antiglare film to a surface of the display device,
wherein adhesion of an adhesive surface of the double-sided adhesive adjacent to the antiglare film is weaker than adhesion of an adhesive surface of the double-sided adhesive adjacent to the display device.

12. The display device according to claim 11, wherein the double-sided adhesive is a double-sided adhesive tape.

13. The display device according to claim 11, wherein the double-sided adhesive attaches the second resin coating layer to the display device.

14. The display device according to claim 11, wherein the adhesion of the double-sided adhesive is such that when a removing force is applied to the antiglare film, the antiglare film separates from the display device, and the double-sided adhesive remains attached to the display device.

15. The display device according to claim 11, wherein the double-sided adhesive comprises:
a first adhesion surface attached to the display device; and
a second adhesion surface removably attached to the second resin coating layer of the antiglare film, wherein the first adhesion surface has a greater adhesive strength than the second adhesion surface,
wherein the second adhesion surface is configured to separate from the second resin coating layer of the antiglare film upon application of a removing force to the antiglare film,
wherein the first adhesion surface is configured to remain attached to the display device upon application of a removing force to the antiglare film,
and wherein when the antiglare film is separated from the display device, the first resin coating layer of the antiglare film is configured to be removably attached to the second adhesion surface of the double-sided adhesive upon application of an attaching force.

16. The display device according to claim 15, wherein when the second resin coating layer is attached to the display device, the antiglare film is configured to reflect less light that reaches the antiglare film than when the first resin coating layer is attached to the display device.

17. The display device according to claim 11, wherein the antiglare layer of the antiglare film comprises:
a plurality of resin beads; and
a resin filling that is wrapped around the beads and calcified.

18. A method of manufacturing an antiglare film, the method comprising:
providing a film having a first surface and a second surface opposite the first surface;
disposing a plurality of resin beads on the second surface of the film;
adhering the plurality of resin beads to the second surface of the transparent film using a resin adhesive;
calcifying the resin adhesive containing the plurality of resin beads to form an antiglare layer;
providing a first resin coating layer at a surface of the antiglare layer; and
providing a second resin coating layer at the first surface of the film.
